(19) United States
(12) Patent Application Publication
(10) Pub. No.: US 2013/0015390 A1
(43) Pub. Date: Jan. 17, 2013

(54) LEAD-ACID ACCUMULATOR MATERIAL AND A FORMING METHOD THEREOF

(71) Applicant: Hsueh-Hung HUANG, New Taipei City (TW)

(72) Inventor: Hsueh-Hung HUANG, New Taipei City (TW)

(21) Appl. No.: 13/179,806

(22) Filed: Jul. 11, 2011

(51) Int. Cl. H01M 10/08; H01M 10/20

(52) U.S. Cl. 252/62.2; 264/105

(57) ABSTRACT

In the present invention, characteristics specific to all kinds of natural mineral and metal are analyzed by a magnetic resonance analyzer. The natural mineral and metal are combined and ground into powder and made into a lead plate, ceramic and a separator of a lead-acid accumulator to produce an undulation frequency and change a molecule structure of an electrolyte, thereby accelerating an ion exchange rate, speeding up a charging rate, increasing a conversion rate, decreasing stacking of lead sulfate crystalloids, reducing a corrosion rate of a positive electrode lattice body and extending a lifetime of use of the lead-acid accumulator.

### BACKGROUND OF THE INVENTION

a) Field of the Invention

The present invention relates to a lead-acid accumulator material and a forming method thereof able to speed up the charging rate, increase the conversion rate, reduce the stacking of sulfuric acid crystalloids, decrease the corrosion rate of a positive electrode lattice body and extend the lifetime of use of the accumulator.

b) Description of the Prior Art

For a conventional accumulator material, a specific effect can only be obtained from a negative ion function, a far-infrared function, a deodorization function and a cation exchange function; whereas, natural mineral, ceramic, coal, charcoal and metal are fused together after each one has been processed individually. According to a rule of thumb, the effect resulting from an individual material must be formed slowly with time.

On the contrary, in some prior arts, ceramic, natural stone or various kinds of raw stone, such as Maifanite stone or Nuwa stone, are mixed together, to manufacture a material product allowing the functions of these materials to develop complementarily. Nevertheless, these prior arts are not quite called the inventions that fully develop the most effective functions to fit with characteristics of the subject to be modified.

On the other hand, in conventional material modification, natural mineral, ceramic, charcoal or coal is processed individually to contact directly with the subject to be modified, same as the modified material manufactured by combining many substances. If an impurity and a foreign object which contain natural mineral, ceramic, charcoal or coal are dissolved and precipitated, the safety consideration is actually not quite perfect. As each having its own characteristics, the metallic material is not appropriate for use in modifying the material, unless it is combined with the natural mineral for a long time to accumulate the change.

Accordingly, there are still a lot of shortcomings in the abovementioned conventional modification of material which is really not a good design, and thus requires to be improved.

### SUMMARY OF THE INVENTION

The primary object of the present invention is to provide a lead-acid accumulator material which is modified by trace elements of natural mineral, wherein an MRA (Magnetic Resonance Analyzer) is utilized to analyze a material made by the natural mineral, allowing it to result in an undulation frequency which is commonly seen in an activated molecule of a high magnetic field, so as to change the molecular structure of an electrolyte that the ion exchange rate can be increased, the charging rate can be increased, the conversion rate can be increased, the stacking of sulfuric acid crystalloids can be reduced, the corrosion rate of a positive electrode lattice body can be decreased and the lifetime of use of the accumulator can be extended.

To achieve the aforementioned object, the present invention uses a fluorescent X-ray to analyze elements which constitute the natural mineral, metal, charcoal or coal. Next, crystalline structures of the abovementioned materials are analyzed by the fluorescent X-ray and then the MRA is used to analyze electromagnetically quality of each substance, finding the optimized composition of each material. To improve the ion exchange rate in the lead-acid accumulator, speed up the charging rate, reduce internal resistance, decrease the stacking of lead sulfate crystalloids, decrease the corrosion rate of the positive electrode lattice body and extend the lifetime of use of the accumulator, it is preferred to use combination of granite and tourmaline, through selecting among the abovementioned materials. As for the optimized mixing ratios of the two, it is determined after utilizing the MRA to study the far-infrared function, the deodorization function, the negative ion function, a function of storage and release of natural cosmic energy, and a magnitude of undulation frequency, as well as to measure a size of cluster (the size of Hz).

It is known after measurement that the abovementioned object can be achieved primarily by adding coal, charcoal, malachite, zeolite, feldspar, Montmorillonite, limestone, gypsum, talcum powder, silver, or combination of the said substances, into powder of granite and tourmaline, followed by grinding into powder and mixing to form a modified material.

To effectively apply the modified material, a different shape of the material can be cast by a mold tool and then sintered in high temperature to become a different shape for application.

In one embodiment, the mixing ratios in weight percents of granite, tourmaline, coal, charcoal, zeolite and silver are 75% of granite, 12% of tourmaline, 6% of charcoal, 2% of zeolite and 5% of silver.

In another embodiment, the modified material can also contain charcoal, malachite, or their combination and the mixing ratios in weight percents are 75% of granite, 13% of tourmaline, 7% of charcoal and 5% of malachite.

In still another embodiment, the steps of combination are:
(1) using the fluorescent X-ray to analyze the elements constituting the natural mineral, metal, charcoal and coal, etc., followed by using the fluorescent X-ray to analyze the crystalline structures of the elements of the said materials;
(2) using the MRA sold on existing markets to study the inherent functions of the said materials;
(3) on the basis of the types of natural mineral (trace elements), carrying out distribution and combination of various proportions, mixing as the compositions that most fit the required characteristics according to an experimental planning and then setting the ratios according to the MRA data;
(4) using the set compositions and ratios to modify the material and processing the characteristics of the subject to be modified, followed by performing a charging test, a discharging test, a test of the lifetime of use and selecting the experiment subject to monitor and evaluate the function tests, in accordance with the purpose of use and the measurement of the state of substances before and after processing, and;
(5) comparing each abovementioned measurement and re-setting the mixing ratios and compositions of natural mineral (trace elements) to obtain the optimized characteristics, whereas in a same time, performing again the measurement and testing of step (4) to determine the optimized compositions and ratios.

Still in another embodiment, the forming steps for modifying the material are:
(a) grinding the raw material into powder of a diameter of 1 mm˜2 mm;
(b) sending the powder-shaped raw material into an agitator for 15 min˜25 min;
(c) adding 6% of charcoal (using white charcoal here), 2% of zeolite and 5% of silver into the mixture which contains 75% of granite and 12% of tourmaline, with that the mixture contents further comprising:
charcoal of an average granular size of 15 mm and made by a broad-leaved tree;
silver of an average granular size of 5 mm; and
other materials of an average granular size of 300 mesh, making the mixed material required for modifying the material;
(d) putting the abovementioned raw materials in an agitator for 20 min˜30 min and then adding in water and agitating uniformly into a mud-shaped substance;
(e) pasting the trace elements of natural energy (mineral) on a lead plate and then maturing to modify the lead-acid accumulator material;
(f) filling the raw materials directly into a mold tool and then sintering at 1000° C. to form a high-tech bio-ceramic for changing the molecular structure of the electrolyte of the lead-acid accumulator;
(g) combining and sintering the mixed materials directly with glass wool made by fine fiber glass to form a separator after modification; and
(h) drying in air to accomplish the material modification of the lead-acid accumulator with the trace elements.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of constituent elements and crystalline structures of a lead-acid accumulator material and a forming method thereof, according to the present invention.

FIG. 2 shows a schematic view of mixed compositions of the lead-acid accumulator material and the forming method thereof, according to the present invention.

FIG. 3 shows a schematic view of the MRA test items of the lead-acid accumulator material and the forming method thereof, according to the present invention.

FIG. 4 shows a schematic view of the cluster test items of the lead-acid accumulator material and the forming method thereof, according to the present invention.

FIG. 5 shows a schematic view of the mixing ratios in using the MRA to study the far-infrared function of the lead-acid accumulator material and the forming method thereof, according to the present invention.

FIG. 6 shows a schematic view of a container of the lead-acid accumulator material and the forming method thereof, according to the present invention.

FIG. 7 shows a schematic view of another container of the lead-acid accumulator material and the forming method thereof, according to the present invention.

FIGS. 8A and 8B show a schematic view of the measurement with the NMR analysis method of the lead-acid accumulator material and the forming method thereof, according to the present invention.

FIG. 9 shows a schematic view of the measurement of a redox potential of the lead-acid accumulator material and the forming method thereof, according to the present invention.

FIG. 10 shows a schematic view of the lead-acid accumulator material and the forming method thereof, according to the present invention, before and after the experiment.

### DETAILED DESCRIPTION OF THE PREFERRED EMBODIMENTS

The existing lead-acid accumulator, also called the lead accumulator, is a kind of accumulator. The electrode is made primarily by lead and the electrolyte is a solution of sulfuric acid. The lead-acid accumulator is generally constituted by a positive electrode plate, a negative electrode plate, a separator, an accumulator tank, an electrolyte and a wiring part. The positive electrode plate is a lead dioxide (PbO₂) plate and the negative electrode plate is a lead plate. The housing and upper lid of the abovementioned accumulator are made by ABS (Acrylonitrile-Butadiene-Styrene) synthetic resin which is of excellent impact resistance and difficult to burn. The positive and negative electrode plates are made by a lead-calcium-tin alloy of corrosion resistance, without releasing any hazardous substance to deposit on the negative electrode plate. Therefore, the lifetime of use of the accumulator can be extended. The positive and negative electrode plates are all paste-type lead electrode plates, the separator is made by glass wool formed by fine absorbent fiber glass, and the wiring part is made integrally by lead for contact between the electrode plates and electrode groups, thereby reducing significantly internal impedance of the accumulator and improving a high-efficiency discharging ability. On the other hand, the electrolyte uses a diluted sulfuric acid, with a moderate fluid volume and not having other free liquid.

Hereinafter the discharging ability, the charging ability and the lifetime of use of the lead-acid accumulator are described.

In terms of the discharging ability, the discharge capacity will depend upon the discharge current (discharge rate). The smaller the discharge current is, the larger the discharge capacity will be. On the other hand, if the discharge current is larger, the discharge capacity will be smaller. Furthermore, the discharge capacity will also depend upon temperature. The lower the accumulator temperature is, the smaller the discharge capacity will be.

In terms of the charging ability, the charging voltage is for the compensation of the charging state to be kept when the accumulator discharges spontaneously. In order to prohibit the shortening of the lifetime of use of the accumulator by charging, the value of this charging voltage should be as small as possible.

In terms of the lifetime of use, the floating life of the accumulator is related to the number of times of discharge, the discharge temperature, the voltage of floating charging and the temperature of environment.

The corrosion rate of the positive electrode lattice body depends upon temperature. The higher the temperature is, the faster the corrosion rate will be and the shorter the floating life will be. In addition, the larger the current of floating charging is, the faster the corrosion rate will be. Therefore, it is very important to use the proper charging voltage to carry out the floating charging.

For all the existing lead-acid accumulators, as some electric conductive oxides are deposited on PbO₂ of the positive electrode plate and Pb of the negative electrode plate during the process of oxidation-reduction of charging and discharging, the sulfuration on the negative electrode plate will result in a trouble that the covered stacking of lead sulfate crystalloids will decrease the area of chemical reaction to clog the circuit, causing that ion exchange cannot be formed and resulting in that the lifetime of use of the lead-acid accumulator is only as short as 1˜2 yr. As a matter of fact, 80% of the wasted lead-acid accumulators are caused by the sulfuration problem. However, this problem can be actually fixed and the lead-acid accumulator can be used again. On the other hand, the lead-acid accumulator material can be modified in advance by high-tech so that the lifetime of use can increase by 5˜6 yr.

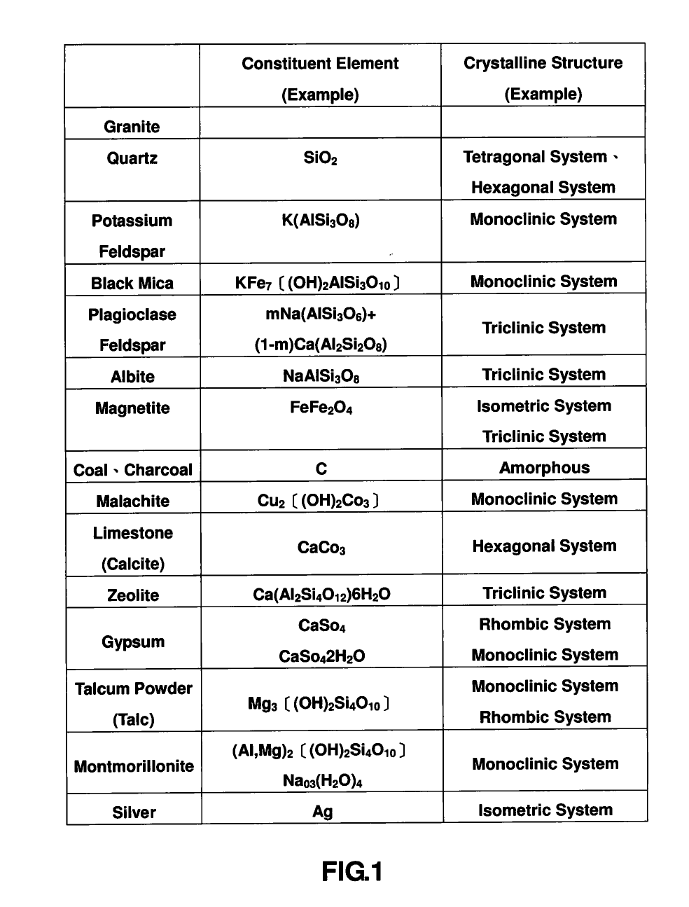

The steps taken by the present invention for obtaining the best combination of natural mineral (trace elements) to modify the material are described below:
1. As shown in FIG. 1, utilizing a fluorescent X-ray to analyze the constituent elements of natural mineral, metal and charcoal, etc., and then using the fluorescent X-ray to analyze the crystalline structures of the abovementioned material elements;
2. Using the MRA sold on the market to study the inherent functions of the abovementioned materials;
3. On the basis of the types of natural mineral (trace elements), carrying out distribution and combination of various proportions to mix as compositions that most fit the required characteristics according to an experimental planning method and then setting the ratios according to the MRA data;
4. Using the modified material with the set compositions and ratios to process and modify the characteristics of the subject to be modified and then in accordance with the purposes of use to measure the material state before and after processing, perform the charging test, the discharging test and the test of the lifetime of use, and select the experiment subject to monitor and carry out the function evaluation and test;
5. Comparing the abovementioned measurements and resetting the ratios and mixing compositions of natural mineral (trace elements) to achieve the best characteristics, in a same time, redoing the measurements and tests of step 4 to determine the optimal compositions and ratios.

To achieve the complex undulation frequency that most fits the subject to be modified, in the abovementioned steps, MRA is applied effectively. Based on the values obtained from MRA, it can be certain that granite is not only provided with very strong far-infrared function and negative ion function, but provided with a very good function of storing natural cosmic energy to change a quality of tap water into that of mineral spring water and high-energy water of small molecules with a ultra high undulation frequency. Tourmaline is provided with an ultra strong negative ion function and a function of facilitating ion exchange and stabilizing hydrogen ions and oxygen ions. In addition to having very strong far-infrared function, negative ion function and bacteriostasis function, coal and charcoal are also provided with excellent deodorization function, energy storage function and adsorption function. Zeolite is provided with a very strong far-infrared function, a bacteriostasis function, a cation exchange function and a natural cosmic energy storage function. Montmorillonite is certain to have excellent far-infrared function, negative ion function, function of releasing natural cosmic energy and cation exchange function. Silver is certain to have excellent bacteriostasis function and germicidal action. On the other hand, malachite is provided with a function of storing natural cosmic energy and a function of facilitating ion exchange. Malachite and gypsum can effectively reduce temperature of charging and speed up an ion exchange rate. The talcum powder is provided with a far-infrared function.

To achieve a complex undulation frequency that most fits the subject to be modified (changing the functions of material), MRA is used again to analyze electromagnetically the quality of each kind of material and come up with the best compositions of the abovementioned materials.

To improve the rate of ion exchange in the lead-acid accumulator, so that the charging rate can be increased, the internal resistance can be reduced, the stacking of lead sulfate crystalloids can be decreased, the corrosion rate of the positive electrode lattice body can be decreased and the lifetime of use can be extended, it is found from selecting among the abovementioned materials that the combination of granite and tourmaline is the best. As for the mixing ratios of the two natural mineral, it is determined by using MRA to study the far-infrared function, the deodorization function, the negative ion function, the function of storing and releasing natural cosmic energy and the magnitude of undulation frequency, as well as to measure the size of cluster (Hz).

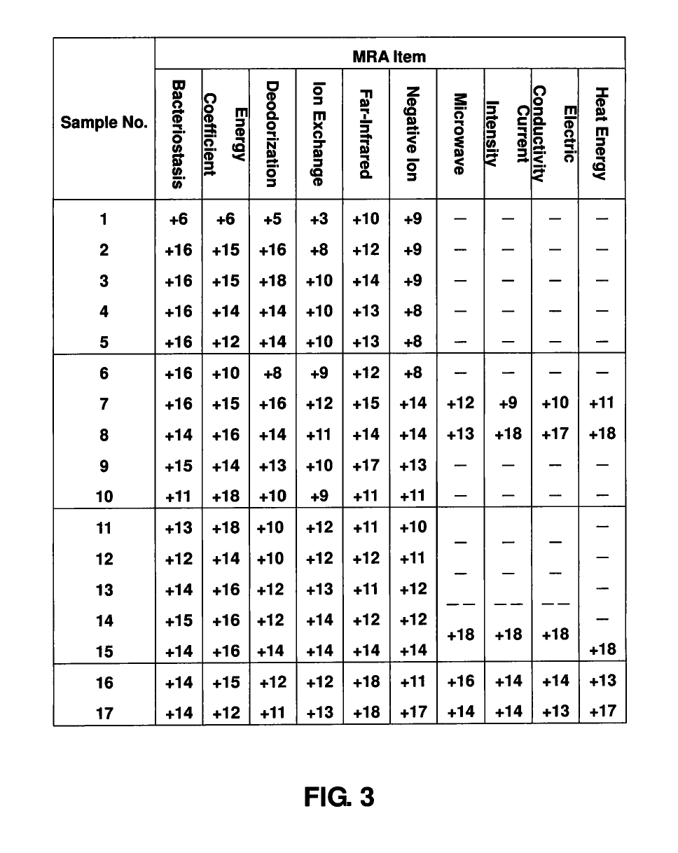

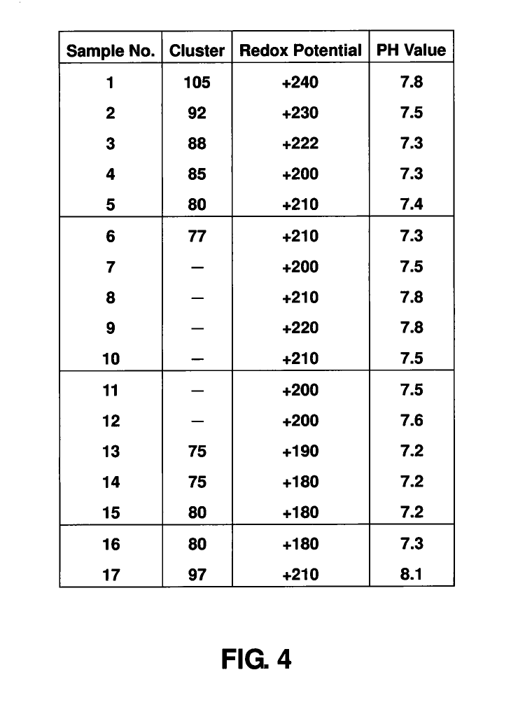

Referring to FIGS. 1, 2, 3, 4 and 9, the data shown in the drawings represent the values of measurement by using a biochemistry analyzer (BA) manufactured by Gerhardt International Company; whereas, Hz is the measured size of cluster by the well known NMR (Nuclear Magnetic Resonance) analysis method.

It can be deducted from this result that the optimal compositions in weight percents are about 70%˜80% of granite and 10%˜15% of tourmaline. Next, when selecting the materials other than granite and tourmaline, MRA is also used to study the abovementioned items for those materials.

It is deducted from the abovementioned result that the optimal compositions in weight percent are about 70%˜80% of granite, 10%˜15% of tourmaline, 6%˜8% of charcoal (using white charcoal here), 3%˜10% of zeolite and 0%˜3% of silver, wherein the basic combination of 75% of granite and 12% of tourmaline achieves the most prominent effect.

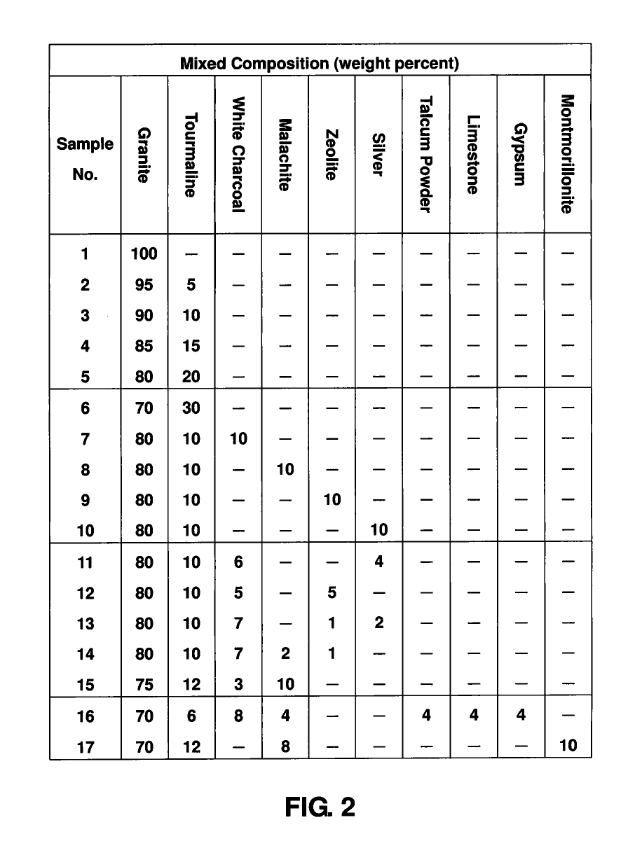

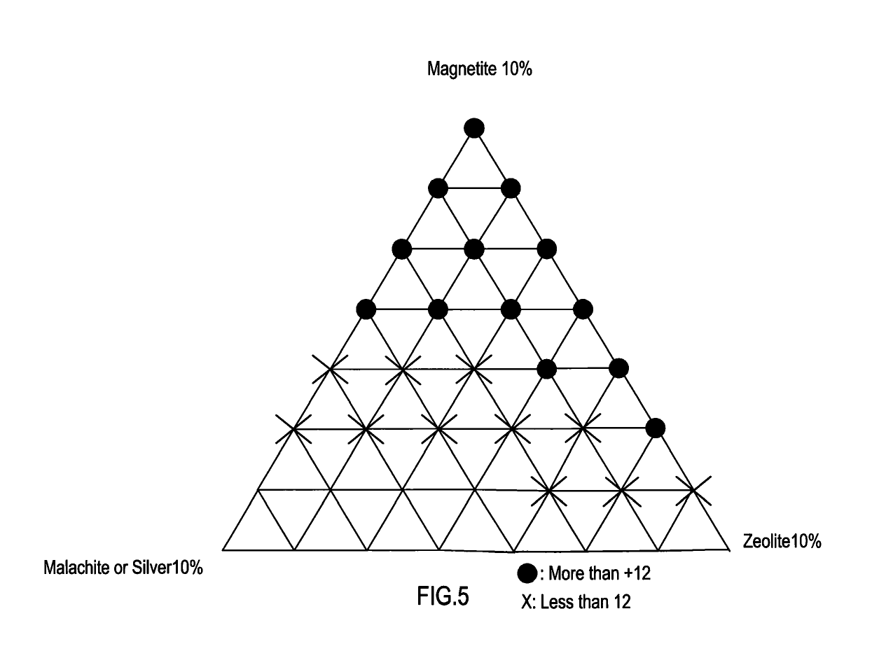

As for the mixing ratios of charcoal, zeolite and silver, the focus is on the condition that the far-infrared item studied by MRA achieves the value of more than +12, as shown in FIG. 5. In the drawing, the symbol of O represents the ratio that achieves the evaluation of more than +12; whereas, the symbol of X represents the ratio not achieved. It can be known from FIG. 2 that the designated evaluation can be achieved by adding 6%˜8% of charcoal, 3%˜10% of zeolite and 0%˜3% of silver into the abovementioned basic combination (75% of granite and 12% of tourmaline), wherein the effect is most stable with 8% of charcoal, 3% of zeolite and 2% of silver.

Hereinafter, the present invention is described in details in reference, but not limited to, the embodiments below.

### Embodiment 1

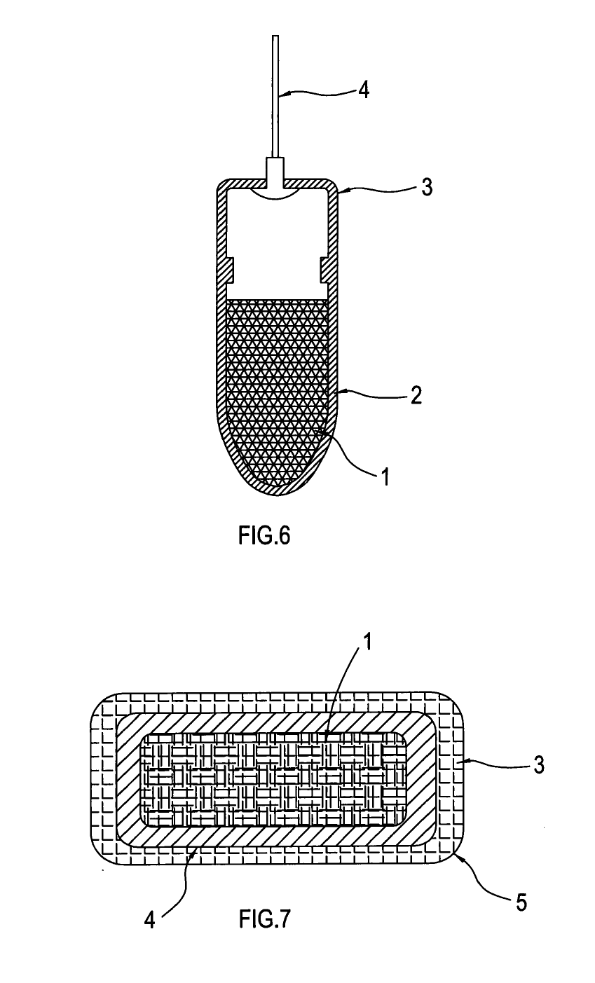

The mixing ratios in weight percents are 75% of granite, 12% of magnetite, 6% of charcoal (here is white charcoal), 2% of zeolite and 5% of silver. The contents of mixture include charcoal made by a broad-leaved tree and of an average granular size of 15 mm, silver of an average granular size of 5 mm and other materials of an average granular size of 300 mesh. Based on these ratios, the mixed material needed for the modification of material of the present invention is formed. This mixed material is loaded and sealed in a container in FIG. 6 and FIG. 7.

The container in FIG. 6 is constituted by a container body 2 which is loaded with the abovementioned mixed material 1 and a cap 3 which seals and clogs an opening part of the container body 2. The container body 2 and the cap 3 are all made by synthetic resin, such as polypropylene or PET (polyethylene terephthalate), or metal such as stainless steel. An accessory 4 is used to suspend this container in water. The accessory 4 is a rope made by synthetic resin and fiber, or a metallic chain.

The container in FIG. 7 is loaded with the abovementioned mixed material 1 and sealed by a copper foil 4. An outer layer of the copper foil 4 is wrapped by a piece of paper 3 which is then enclosed by an aluminum foil 5.

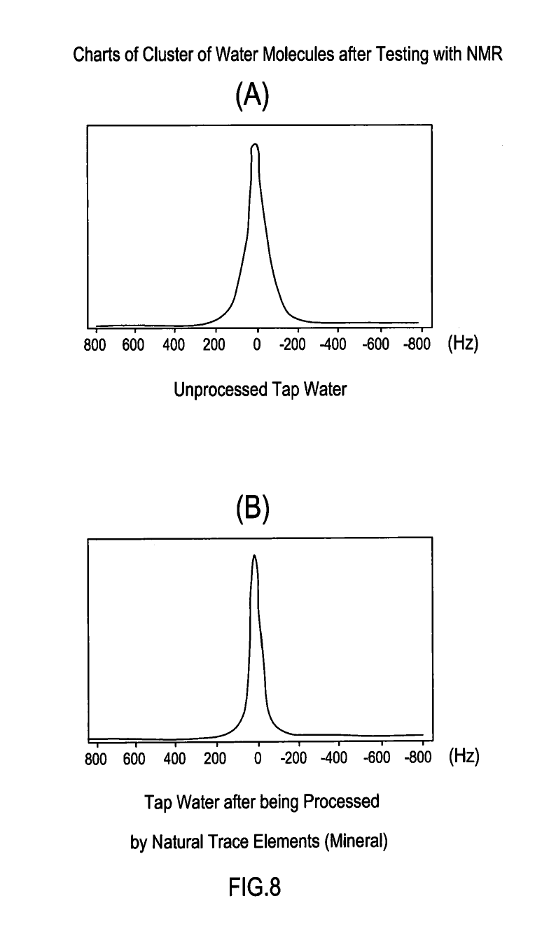

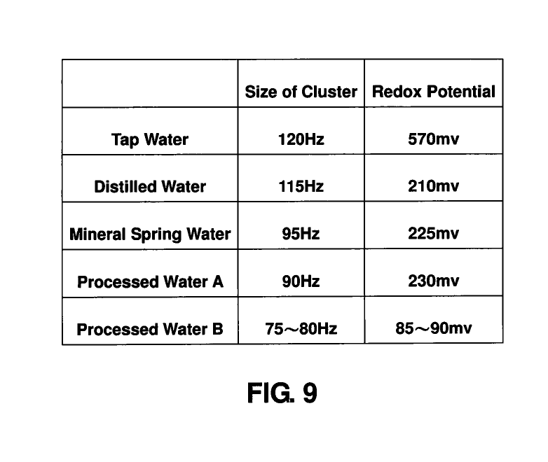

The container that is loaded with the abovementioned mixed material and is sealed is thrown into tap water and distilled water of 1 liter each and then put in there for about half an hour. The well known NMR analysis method is then used to measure the water through this processing (or the processed tap water A) and the size of cluster of the tap water before processing. The results are shown in FIG. 8, wherein (A) is the unprocessed tap water, and (B) is the processed tap water A. The size of cluster can be computed by putting the measured results into a formula. Similarly, the processed distilled water (processed water B) and the unprocessed distilled water and mineral spring water are measured respectively. The results are shown in FIG. 9. Besides, the redox potentials are measured with a measuring instrument sold on the market (e.g., RM12P manufactured by Japan East Asia Electric Wave Industrial Corporation) and the results are shown in FIG. 9.

It is known from the results above that the tap water (processed water A) which has been undergone with the modification by the present invention is provided with compatible data with the mineral spring water sold on the market, in terms of the cluster size and the redox potential; both water are tasteful and of a good quality. In addition, as the cluster of water molecules is smaller, the processed tap water can be absorbed by a human body more easily, is provided with better circulation ability and food does not get decomposed easily. Furthermore, the distilled water (processed water B) through the modification by the present invention is even more prominent in the effect of modification, achieving the water of a very good quality.

### Embodiment 2

The present embodiment is formed by granite, tourmaline, charcoal (white charcoal here), zeolite and silver. The abovementioned raw materials are ground into powder and then mixed and agitated in an agitator. Next, water is added in and the mixture is agitated uniformly as a mud-shaped substance which is then pasted on a lead plate to be sent into a sintering furnace. The lead plate which is modified by trace elements is accomplished after the lead plate is matured and dried in air.

The steps of processing are:
(a) grinding the raw materials into powder of a diameter of 1 mm˜2 mm;
(b) sending the powder-shaped raw materials into an agitator for 15 min˜25 min;
(c) adding 6% of charcoal (using white charcoal here), 2% of zeolite and 5% of silver into the mixture which contains 75% of granite and 12% of tourmaline, with that the mixture contents further comprising:
charcoal of an average granular size of 15 mm and made by a broad-leaved tree;
silver of an average granular size of 5 mm; and
other materials of an average granular size of 300 mesh, making the mixed material required for modifying the material;
(d) putting the abovementioned raw materials in an agitator for 20 min˜30 min and then adding in water and agitating uniformly into a mud-shaped substance;
(e) pasting the trace elements of natural energy (mineral) on a lead plate and then maturing to change the lead-acid accumulator material;
(f) filling the raw materials directly into a mold tool and then sintering at 1000° C. to form a high-tech bio-ceramic for changing the molecular structure of the electrolyte of the lead-acid accumulator;
(g) combining and sintering the mixed materials directly with glass wool made by fine fiber glass to form a separator after modification; and
(h) drying in air to accomplish the material modification of the lead-acid accumulator with the trace elements.

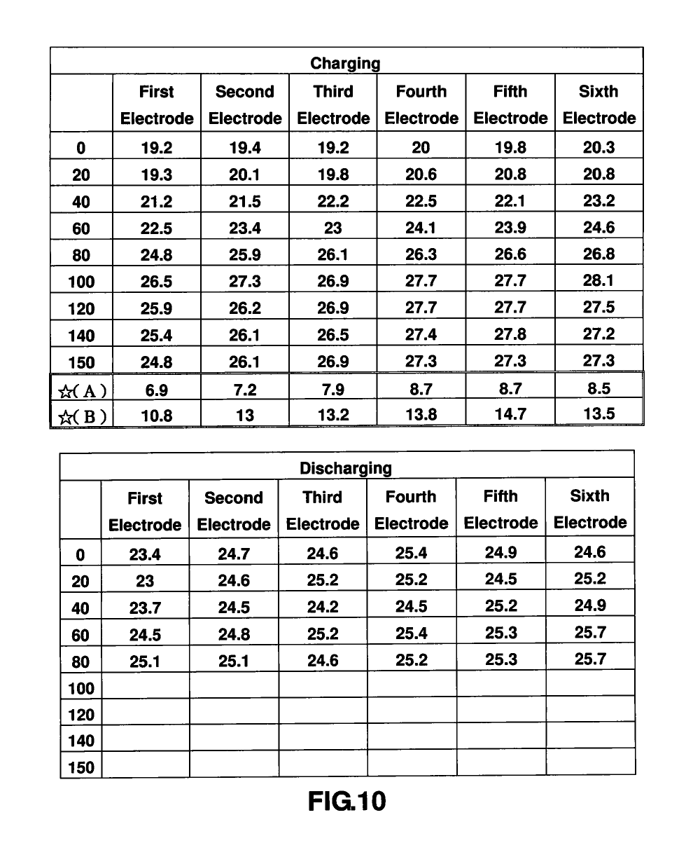

From experiments, after modifying the material with natural trace elements (mineral), the charging temperature of the lead-acid accumulator will drop down as shown in FIG. 10, wherein (A) is the temperature after modifying with the natural trace elements of mineral and (B) is the temperature of the material which is not modified.

In theory, the molecular resonance energy level is computed by the gas theory of electron in the quantum mechanics. The basic molecular resonance potential of this kind of molecule is estimated to be 0.09 eV˜0.42 eV. The following photon kinetic energy can be obtained further by the Planck's formula:

λ(μm)=1.2398 (eV-μm)/E(eV),

where, λ is the wavelength of photon in the unit of μm, E is the kinetic energy of photon in the unit of eV. The photon of wavelength of 4 μm˜15 μm can provide sufficient energy to overcome the potential energy of 0.09 eV˜0.42 eV, allowing the electrons that were trapped in the force field to be vibrated and excited, thereby increasing the resonance energy.

Accordingly, the high-tech bio-ceramic and separator, lead plate are all made by natural trace elements of mineral which produce the undulation frequency commonly seen in an activated molecule of a high magnetic field, thereby changing the molecule structure of the electrolyte to accelerate the ion exchange rate, speed up the charging rate, increase the conversion rate, reduce the stacking of lead sulfate crystalloids, decrease the corrosion rate of the positive electrode lattice body and extend the lifetime of use of the lead-acid accumulator.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A lead-acid accumulator material and a forming method thereof, comprising a modified material which is made by mixing and grinding into powder of granite and tourmaline powder, and then added by coal, charcoal, malachite, zeolite, feldspar, Montmorillonite, limestone, gypsum, talcum powder, silver, or combination of the abovementioned materials.

2. The lead-acid accumulator material and the forming method thereof, according to claim 1, wherein the mixing ratios in weight percents of granite, tourmaline, charcoal, zeolite and silver are 75% of granite, 12% of tourmaline, 6% of charcoal, 2% of zeolite and 5% of silver.

3. The lead-acid accumulator material and the forming method thereof, according to claim 1, wherein the material further comprising charcoal, malachite or their combination, with that the mixing ratios in weight percents of each material are 75% of granite, 13% of tourmaline, 7% of charcoal and 5% of malachite.

4. The lead-acid accumulator material and the forming method thereof, according to claim 1, wherein after mixing, the modified material is cast into various shapes with a mold tool and then sintered at high temperature into various shapes.

5. The lead-acid accumulator material and the forming method thereof, according to claim 2, wherein after mixing, the modified material is cast into various shapes with a mold tool and then sintered at high temperature into various shapes.

6. The lead-acid accumulator material and the forming method thereof, according to claim 3, wherein after mixing, the modified material is cast into various shapes with a mold tool and then sintered at high temperature into various shapes.

7. The lead-acid accumulator material and the forming method thereof, according to claim 1, comprising steps of:
(a) grinding the raw materials into powder of a diameter of 1 mm˜2 mm;
(b) sending the powder-shaped raw materials into an agitator for 15 min˜25 min;
(c) adding 6% of charcoal (using white charcoal here), 2% of zeolite and 5% of silver into the mixture which contains 75% of granite and 12% of tourmaline, with that the mixture contents further comprising:
charcoal of an average granular size of 15 mm and made by a broad-leaved tree;
silver of an average granular size of 5 mm; and
other materials of an average granular size of 300 mesh, making the mixed material required for modifying the material;
(d) putting the abovementioned raw materials in an agitator for 20 min˜30 min and then adding in water and agitating uniformly into a mud-shaped substance;
(e) pasting the trace elements of natural energy (mineral) on a lead plate and then maturing to change the lead-acid accumulator material;
(f) filling the raw materials directly into a mold tool and then sintering at 1000° C. to form a high-tech bio-ceramic for changing the molecular structure of the electrolyte of the lead-acid accumulator;
(g) combining and sintering the mixed materials directly with glass wool made by fine fiber glass to form a separator after modification;
(h) drying in air to accomplish the material modification of the lead-acid accumulator with the trace elements.
